(19) United States
(12) Patent Application Publication
(10) Pub. No.: US 2008/0031161 A1
(43) Pub. Date: Feb. 7, 2008

(54) METHOD AND SYSTEM FOR ESTABLISHING A CONFERENCE CALL BETWEEN A REMOTE AND A LOCAL ENDPOINT

(75) Inventors: Egil OSTHUS, Oslo (NO); Olve Maudal, Kolsas (NO)

Correspondence Address: OBLON, SPIVAK, MCCLELLAND MAIER & NEUSTADT, P.C., 1940 DUKE STREET, ALEXANDRIA, VA, 22314, US

(73) Assignee: Tandberg Telecom AS, Lysaker (NO)

(21) Appl. No.: 11/773,208

(22) Filed: Jul. 3, 2007

(30) Foreign Application Priority Data
Jul. 7, 2006 (NO) 20063176

(51) Int. Cl. H04L 12/16

(52) U.S. Cl. 370/261

(57) ABSTRACT

The present invention provides a method and a system for establishing a conference call between a first conference endpoint and a second conference endpoint. This is achieved by means of a soft client residing on a portable communication terminal, which is able to receive and initiate calls from/to the first endpoint, and to establish a local connection with and move the call to the second endpoint, in order to exploit the high quality features available in the second conference endpoint.

### FIELD OF INVENTION

The present invention relates to establishing of conference calls, and more particularly to a method and a system for establishing a conference call between a first conference endpoint and a second conference endpoint.

### TECHNICAL BACKGROUND

In order to have a meeting involving participants not located in the same area, a number of technological systems are available. These systems may include video conferencing, web conferencing and audio conferencing.

The most realistic substitute for real meetings is high-end video conferencing systems. Conventional video conferencing systems comprise a number of endpoints communicating real-time video, audio and/or data streams over WAN, LAN and/or circuit switched networks. The endpoints include one or more monitors, cameras, microphones and/or data capture devices and a codec, which encodes and decodes outgoing and incoming streams, respectively. In addition, a centralized source, known as a Multipoint Control Unit (MCU), is needed to link the multiple end-points together. The MCU performs this linking by receiving the multimedia signals (audio, video and/or data) from endpoint terminals over point-to-point connections, processing the received signals, and retransmitting the processed signals to selected endpoint terminals in the conference. Video conferencing systems range from large boardroom systems with multiple plasma screens to relatively small desktop systems for individual workspace.

Another common substitute for real meetings is web conferencing. Web conferencing is based on computer software for coordination meetings and communicating real-time video, audio and/or data streams over WAN, LAN and/or circuit switched networks. In order to participate in a web conference, a computer with internet access is needed, as well as speakers, a microphone, a web camera, and a software client. Web conferencing is a cost-efficient solution for online visual collaboration, but audio and video quality is poor compared to video conferencing.

Business has become increasingly mobile with service calls, remote visits and travels all playing a bigger role in day-to-day operation. It is important for business travellers to be accessible for visual communication when visiting remote sites, e.g. to attend important meetings, contact developers at the home office for support, arrange meetings between the home office and the visited site, keep in touch with family, etc. However, when travelling from site to site, it is highly inconvenient to bring high level video conferencing equipment, considering physical size and configuration issues.

Nevertheless, if video conferencing equipment was brought to a remote site, it is not always a straight forward task to set up at VC system on a new network. Many public sites like hotels, airports, etc. and even entire cities now offer WLAN or LAN to guests. However, registration is often required through a web based interface in order for guests to connect to these networks. Such registration procedures are quite easy and self explanatory when using a laptop computer, but can be challenging, if not impossible, with standard video conferencing endpoints.

Even if visiting users have access to video conferencing equipment on the visited site, a large problem with ad-hoc scheduling is knowledge of which resources are available to the user. In many cases, it is necessary for the one that is calling to ask the participants in person about which localizations and systems etc. are accessible to them at the particular moment, which accessories and services they have available or which is preferable, and the systems URI. The lack of knowledge regarding the participants' access and preferences is the main reason that ad-hoc conferences are difficult to set-up, they simply require too much fluctuating knowledge of the far end side from the users. Further, the VC equipment on the visited site may be temporarily off-line due to configuration- or infrastructure problems. Also, scheduled call launches requires the (human) user to be available on a system that is managed by the corporate management system. Being available on foreign VC equipment will not support scheduled automatic call launches. Today this is solved by dialing in to the conference on predefined numbers. Lack of knowledge regarding the visited VC equipment once again comes into play.

Therefore, an on-screen soft client is more convenient for mobile business. Business travellers bring a laptop or similar mobile devices anyway for other purposes. A soft client running on a mobile device provides the user with a single point of contact with no need for re-configuration. Further, mobile devices suitable for web conferencing are easy to connect to new networks, and have built-in security and network configuration software for a secure line back to the home office. However, a soft client does not have the same specialized hardware as stand alone video conference systems, and consequently does not provide the user with the same high audio and video quality as a stand alone client.

Further, because of limited screen space and quality, web conferencing is only suitable for individual workspace. If presentations or other programs are used during the conference, the user is forced to switch between programs loosing visual contact with the other participants, or to reduce the size of the conference window, hence reducing visual feedback. A personal computer and its input/output devices (microphone, loudspeaker, screen, etc.) are not designed to handle situations where several users are situated in the same room, consequently providing poor audio and video signals leading to miscommunication, whereas video conferencing equipment is specifically designed to handle such environments.

### SUMMARY OF THE INVENTION

It is an object of the present invention to provide a method and a system for establishing a conference call between a first conference endpoint and a second conference endpoint.

The invention is defined by the features of the appended claims.

Consistent with certain aspects of the present invention, the desired features of the soft client (single point of contact, security handled by underlying in-place technology e.g. VPN and no re-configuration when travelling from site to site) are combined with the desired capabilities of the hard client (specialized hardware providing high quality sound and video) to provide the mobile users with a more complete video experience than possible today.

Further consistent with certain aspects of the present invention, a soft client residing on a mobile device is able to receive and initiate calls from/to a remote endpoint, and to establish a local connection with and move the call to a nearby endpoint, in order to exploit the high quality features available in the stand alone hard client.

### BRIEF DESCRIPTION OF THE DRAWINGS

The present invention will be described in detail with reference to a preferred embodiment as shown in the following drawings:

FIG. 1 is a schematic block diagram of a system configured to operate in accordance with the invention.

FIG. 2 is a flow chart that schematically shows the communication between the remote endpoint and the MRC, and the MRC and the local endpoint when a remote endpoint is initiating a call.

FIGS. 3a and 3b are flowcharts that schematically shows the communication when the MRC is unable to establish contact with the local endpoint.

FIG. 4 is a flow chart that schematically shows the communication between the remote endpoint and the MRC, and the MRC and the local endpoint when the MRC is initiating a call.

FIG. 5 is a flow chart that schematically shows the communication when the MRC is unable to establish contact with the local endpoint.

FIG. 6 is a flow chart that schematically shows the communication when the MRC is moving a conference call from a soft client on the mobile device to a nearby endpoint.

### DETAILED DESCRIPTION OF THE INVENTION

In the following, the present invention will be discussed by describing a preferred embodiment, and by referring to the accompanying drawings. However, people skilled in the art will realize other applications and modifications within the scope of the invention as defined in the enclosed independent claims.

Throughout the specification, the term “endpoint” is used to refer collectively to an audiovisual endpoint terminal.

The present invention provides a system and a method making it possible for a portable communication terminal (e.g. laptop, PDA, etc.) to handle calls to and from a first, remote endpoint, and then forward the audio-, video- and/or data streams to a second, local (i.e., nearby) endpoint to exploit the high quality features available in the stand alone hard client (endpoint). This is utilised by a SIP User Agent (SIP UA), hereafter referred to as Media Relay Client (MRC), residing on and being executed by the portable communication terminal. Through a local network connection (WLAN, LAN, WiFi, etc.) on the portable communication terminal the MRC is able to receive or initiate calls from or to any SIP enabled endpoint. The MRC is also configured to search for nearby video conferencing systems by means of wireless technology, and to establish communications with an endpoint selected by the user. The MRC further makes it possible to move any call to a chosen nearby system. E.g. if an endpoint (close to the portable communication terminal) has a larger screen, it is possible to utilize this larger screen for all calls directed to or established by the MRC. The MRC will at any time provide its user with overview of the nearby available endpoints. The media relay user can therefore at any time decide to forward the media streams to another more appropriate endpoint. If there is no endpoint nearby, the media streams can be forwarded to a soft client on the portable communication terminal, hence proceeding with the video conference on portable communication terminal.

In an embodiment the MRC utilize SIP technology for setting up communications sessions. SIP is an Internet Engineering Task Force (IETF) standard protocol for initiating an interactive user session that involves multimedia elements such as video, voice, chat and gaming. SIP is a request-response protocol, dealing with requests from clients and responses from servers. Participants are identified by SIP URIs (Uniform Resource Identifier). Requests can be sent through any transport protocol, such as UDP, SCTP, or TCP. SIP determines the end system to be used for the session, the communication media and media parameters, and the called party's desire to engage in the communication. Once these are assured, SIP establishes call parameters at either end of the communication, and handles call transfer and termination. SIP requires a central server i.a. for signalling, registration and policy handling.

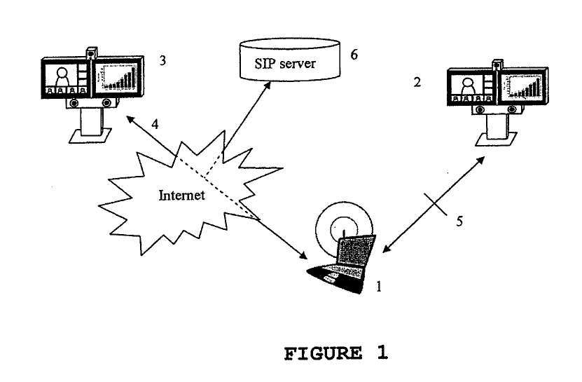

FIG. 1 is a schematic block diagram of a system configured to operate in accordance with the invention. FIG. 1 illustrates a typical usage of the portable communication terminal 1 as a media relay device, i.e. for facilitating the establishing of a conference call between a first, remote conference endpoint 3 and a second, local conference endpoint 2.

Consistent with the principles of the invention, the conference call is established by the steps of establishing a remote communication between the portable communication terminal 1 and the first conference endpoint 3 through the communication network, such as the Internet; establishing a local communication between the mobile communication terminal 1 and the second conference endpoint 2 through the local communication connection 5; and then establishing a conference communication between the first 3 and the second 2 conference endpoints.

In an embodiment, the resulting communication between the first 2 and the second 3 conference endpoints takes place via the portable communication terminal 1. It is also possible that the resulting communication is performed via another communication channel, e.g. the communication network, depending on the communication capabilities of the second conference endpoint in particular.

In an embodiment, the above steps are performed by the portable communication terminal 1.

In an embodiment, the establishing of a remote communication comprises establishing a SIP dialog between the mobile communication terminal 1 and the first conference endpoint 3.

This communication may be of a secure type, in which case the portable communication terminal 1 has established a secure line 4 back to the home network, e.g. by using VPN.

The portable communication terminal 1 also has a connection 5 to a nearby available endpoint 2 on a wired or wireless interface (e.g. Bluetooth, IR, WiFi, etc.).

A secure line back to the home office is not required for making a call or establishing a SIP dialog with the remote endpoint 3, but when a call is made to or from the home office, such a secure line, e.g. provided by a VPN connection, will prevent others from intercepting the call when routed through the public internet.

All endpoints may be reached, however it is important to ensure that encryption is supported by both endpoints if sensitive calls are made without a secure line.

When the portable communication terminal 1 is connected to the network, such as the Internet, the user is required to log on to the MRC with its unique SIP URI. The SIP URI is the users “phone number” and may look something like this: name.surname@company.com. Once the user is logged in, the MRC registers the SIP URI and the current IP-address of the mobile device on a SIP server (6).

A SIP proxy is not required when establishing contact between the media relay client and the visited endpoint. The SIP dialog is established by directly sending SIP messages between the media relay device and the nearby endpoint 2.

Consistent with a further feature, the media relay client in the portable communication terminal 1 is configured for keeping track of its position, in particular its indoor position. This can e.g. be done by using known techniques like Rapidly Installable Positioning Systems for Indoor Environments, RAPOSI or Cordis RadioEye™ Localisation Technology.

When changing its position, the media relay client will automatically perform a service discovery. This discovery is needed to be able to provide the user with choices on where to forward the media streams. Well known wireless technology like Bluetooth or 802.11 WLAN can be used for this purpose depending on preferred or available communication channels between the portable communication terminal and the nearby endpoints. Ideally the distance to each endpoint is obtained and displayed, as well as the name of each endpoint. If tracking capabilities are unavailable, service discovery may of course be initiated manually by the user at any time to identify nearby endpoints. It is important to realize that the nearby endpoint discovery is not required for the media relay service to function. Alternatively the user is queried for the SIP URI of the nearby endpoint when a connection is to be made.

If wireless communication is not supported by the nearby endpoints, or a wired connection is preferred, a standard wired connection (Ethernet/EEE 802.3) can be established between the media relay device and the preferred endpoint. When a wired connection is established, the endpoint will automatically appear in the list of available endpoints.

The media relay client on the portable communication terminal 1 will negotiate the call setup with the remote endpoint on behalf of the nearby endpoint. There are basically two different scenarios; the MRC receives an outside call request that is forwarded to the nearby VC equipment, and that the call is initiated from the MRC (using the nearby endpoint 2 as source for media I/O) to a remote endpoint 3.

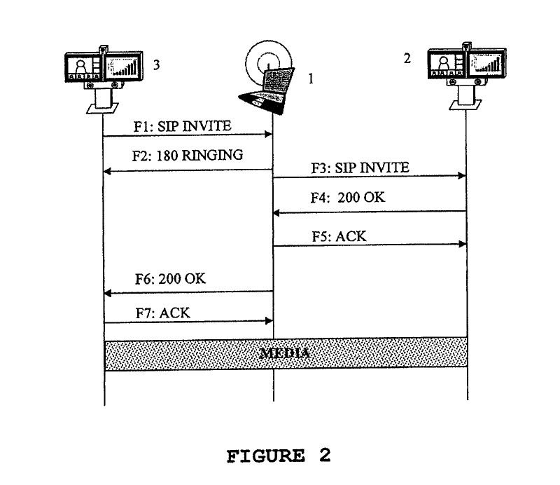

The first scenario where the MRC receives a call request from a remote endpoint is shown in FIG. 2, and illustrates the 3-way handshake for establishing a call when the MRC receives a SIP INVITE. The MRC will first receive a SIP INVITE (F1) from the remote endpoint 3. The SIP INVITE (F1) provides the MRC with information about remote endpoints capabilities, e.g. available audio protocols, video protocols, etc, and its IP address. The MRC does not know the capabilities of the nearby endpoint 2 at this moment, consequently the MRC can not respond to the INVITE message yet. The media relay therefore sends a “SIP 180 RINGING” (F2) to inform the remote endpoint 3 that the call is being handled. The MRC initiates a new SIP session with the nearby endpoint 2, by sending a SIP INVITE (F3) message containing the Session Description Protocol (SDP) information derived from F1 and the IP-address of the portable communication terminal 1. The SDP contains information about audio- and video protocols, encryption protocols, etc. available to the remote endpoint. The nearby endpoint responds to the invite message F3 with a 200 OK (F4), accepting the call. The message F4 includes a SDP, containing information about audio- and video protocols, encryption protocols, etc. available to the nearby endpoint 2, and the IP-address of the nearby endpoint 2. When the 3-way handshake between the MRC and the nearby endpoint 3 is finished (F5), the media relay knows what capabilities that is preferred by both remote endpoint and nearby endpoint. The MRC creates an 200 OK message (F6), containing information about audio- and video protocols, encryption protocols, etc. available to the nearby endpoint 2 and the IP-address of the portable communication terminal, and sends it to the remote endpoint, completing the 3-way handshake between the MRC and the remote endpoint. Notice that two different SIP dialogs are established; one between the remote endpoint and MRC, and one between the MRC and nearby endpoint.

When receiving the accept message (F6) the remote endpoint knows the capabilities of the receiving endpoint, and adjusts the coding accordingly. The remote endpoint 3 will now send the media stream to the portable communication terminal 1, which forwards it to the nearby VC endpoint, substantially without any processing. All the decoding and coding of media is now performed by the endpoints, whilst the MRC on the portable communication terminal 1 acts as a relay node in the network. The only essential processing performed by the mobile device is the redirecting of media packets. The endpoints will only “see” the portable communication terminal 1.

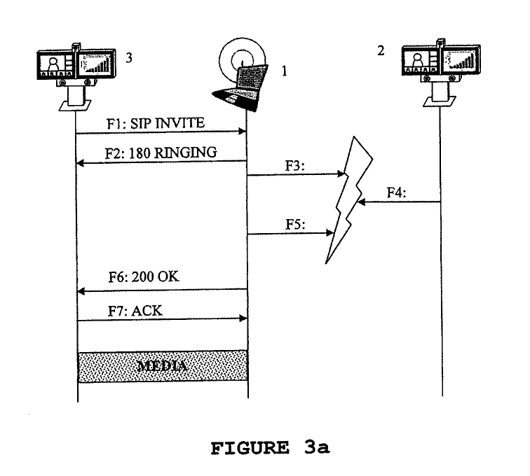

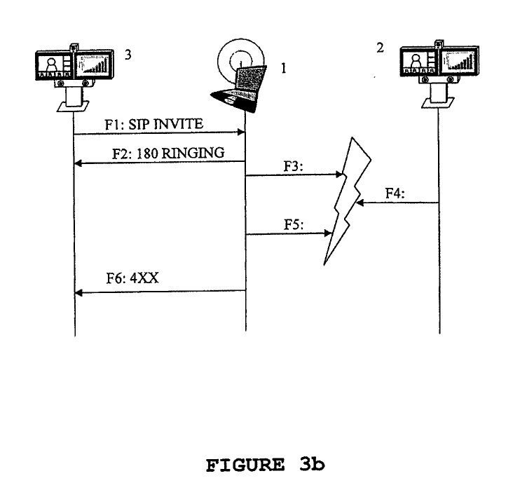

There might be cases where the media relay is not able to establish contact with the nearby endpoint 2. FIG. 3a illustrates a situation where F3, F4 or F5 fails. If a SIP User Agent (UA) soft client is available on the device running the media relay client, the MRC will send the SIP INVITE (F1) message to the internal SIP UA. The internal SIP UA will then complete the 3-way handshake and establish a media session between the remote endpoint and the SIP UA running on the mobile device.

If the mobile device does not have an available SIP UA, the media relay will respond to the far end VC endpoint with a 4XX SIP message, indicating that the session could not be established. This scenario is illustrated in FIG. 3b.

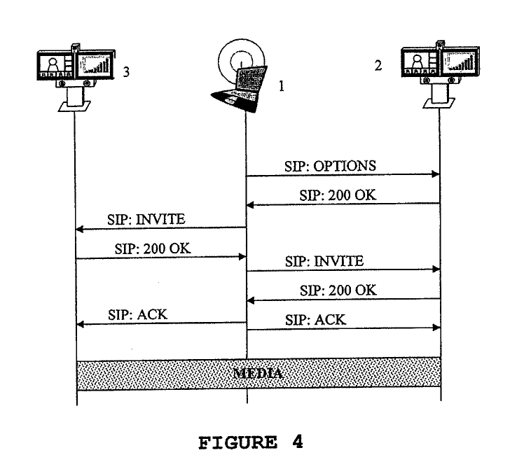

Alternatively, the call may be initiated from the portable communication terminal, as shown in FIG. 4. The session starts with the MRC query (F1), for establishing the available nearby endpoints capabilities. The MRC query (F1) is a SIP OPTIONS message. The SIP OPSTIONS message is used to discover the nearby endpoints capabilities prior to the call setup.

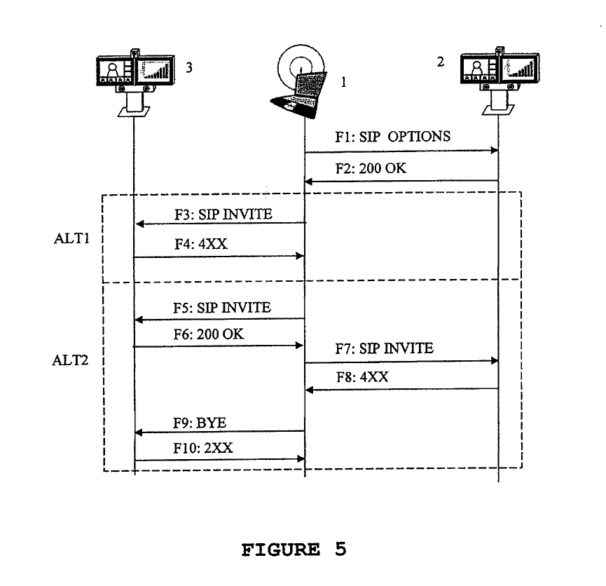

There might be cases where the three-way handshake is not completed. As shown in FIG. 5, two different instances may occur. Either the remote endpoint refuses to accept the invitation, or the nearby VC endpoint refuse to accept the invitation. This may be caused by timeouts, system malfunctions, etc.

The first alternative (ALT1) in FIG. 5 illustrates when the remote endpoint 3 refuses to accept the INVITE (F3) from the MRC. In this case, no actions are needed since no messages are sent to the nearby endpoint 2. In the second alternative (ALT2), a dialog is already established between the remote endpoint 3 and the media relay client in the portable communication terminal 1, but the nearby endpoint 2 denies the subsequent INVITE message (F7). The media relay client will then send a BYE message (F9) to the remote VC endpoint in order to close the established dialog (established by F6). The Dialog is finally terminated by the 2xx message (F10) from the remote endpoint 3 to the MRC/portable communication terminal 1.

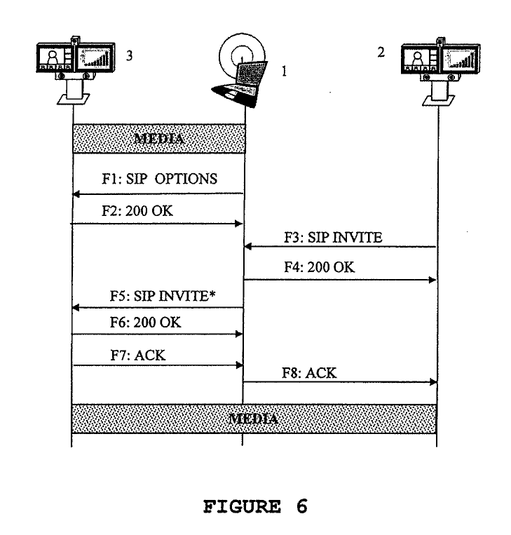

As mentioned earlier, a call may be established on a SIP enabled soft client residing on the portable communication terminal. The soft client may be part of the media relay client itself or a separate soft client. At some point during the conference, the user might want to switch to a nearby stand alone VC unit. FIG. 6 illustrates a situation where a media session is established between the remote endpoint 3 and the portable communication terminal 1, after which the call is moved to a nearby endpoint 2. The media relay client in the portable communication terminal 1 does not necessarily have to store any information about the session descriptors when a session is terminated. The relationship between the media relay client and nearby endpoints is expected to be short lived and continuously changing. Consequentially such information is of no value to the media relay. Hence, when an appropriate nearby endpoint have been detected and chosen by the user, the media relay client will request (F1) system information from the remote VC endpoint. The media relay client then sends a SIP INVITE (F3) to the nearby endpoint 2 with a SDP based on the OPTIONS response (F2) from the remote endpoint 3. Based on the responses F2 and F4, the media relay client compares the two session descriptors from both endpoints to establish operability. If there is a need to re-establish the media session, the media relay client will send the remote endpoint 3 a re-invite message (F5). If so, only the media descriptors are modified.

1. Method for establishing a conference call between a first conference endpoint and a second conference endpoint,
characterized in that the method comprises the steps of:
establishing a remote communication between a portable communication terminal which is operatively connected to a communication network, and said first conference endpoint through said communication network;
establishing a local communication between said mobile communication terminal and said second conference endpoint through a local communication connection; and
establishing a conference communication between said first and second conference endpoints.

2. Method according to claim 1,
wherein said step of establishing a conference communication between said first and second conference endpoints comprises establishing said communication via said portable communication terminal.

3. Method according to claim 1 or 2,
performed by said portable communication terminal.

4. Method according to one of the claims 1 to 3,
wherein said step of establishing a remote communication comprises establishing a SIP dialog between said mobile communication terminal and said first conference endpoint.

5. Method according to one of the claims 1-4, wherein said step of establishing a remote communication comprises:
receiving an invite message from said first conference endpoint, said invite message including an identifier identifying said first conference endpoint, and
transmitting an acknowledge message to said first conference endpoint.

6. Method according to one of the claims 1-4, wherein said step of establishing a remote communication comprises:
transmitting an invite message to said first conference endpoint, said invite message including an identifier identifying said mobile communication terminal, and
receiving an acknowledge message from said first conference endpoint.

7. Method according to claim 6, wherein said step of transmitting an invite message is preceded by the steps of
determining a set of potential conference endpoints that are available for local communication with the mobile communication terminal, and
selecting said second conference endpoint among said set of potential conference endpoints.

8. Method according to one of the claims 1-7,
wherein said step of establishing a local communication comprises establishing a SIP dialog between said portable communication terminal and said second conference endpoint.

9. Method according to claim 8,
wherein said local communication is selected from the following set of communication types: WLAN, Bluetooth, WiFi.

10. Method according to one of the claims 1-9,
wherein said step of establishing a local communication comprises:
transmitting an invite message to said second conference endpoint, said invite message including an identifier identifying said portable communication terminal, and
receiving an acknowledge message from said second conference endpoint.

11. Method according to one of the clams 1-10,
wherein said step of establishing said conference communication between said first and second conference endpoints comprising
relaying conference media between said endpoints via said mobile communication terminal.

12. Method according to one of the claims 1-4 or 6-11, wherein the portable communication terminal includes a conference soft client,
the method further comprising the step of
establishing a conference communication between said first endpoint and said conference soft client in said portable communication terminal, and
moving said conference communication from said mobile communication terminal to said second conference endpoint by establishing a conference communication between said first and second conference endpoints.

13. System for establishing a conference call between a first conference endpoint and a second conference endpoint,
characterized in that the system comprises
a portable communication terminal, operatively connected to a communication network and configured to
establish a remote communication between said portable communication terminal and said first conference endpoint through said communication network;
establish a local communication between said mobile communication terminal and said second conference endpoint through a local communication connection; and
establish a conference communication between said first and second conference endpoints.

14. System according to claim 13,
wherein said portable communication terminal is configured to establish said communication between said first and second conference endpoints via said portable communication terminal.

15. System according to claim 13 or 14,
wherein said portable communication terminal is configured to establish a remote communication by establishing a SIP dialog between said portable communication terminal and said first conference endpoint.

16. System according to one of the claims 13-15, wherein said portable communication terminal is configured to:
receive an invite message from said first conference endpoint, said invite message including an identifier identifying said first conference endpoint, and
transmit an acknowledge message to said first conference endpoint.

17. System according to one of the claims 13-15, wherein said portable communication terminal is configured to:
transmit an invite message to said first conference endpoint, said invite message including an identifier identifying said mobile communication terminal, and
receive an acknowledge message from said first conference endpoint.

18. System according to claim 17, wherein said portable communication terminal is configured to, preceding the step of transmitting an invite message,
determine a set of potential conference endpoints that are available for local communication with the portable communication terminal, and
select said second conference endpoint among said set of potential conference endpoints.

19. System according to one of the claims 13-18,
wherein said step of establishing a local communication comprises
establishing a SIP dialog between said portable communication terminal and said second conference endpoint.

20. System according to claim 19,
wherein said local communication is selected from the following set of communication types: WLAN, Bluetooth, WiFi.

21. System according to one of the claims 13-20, wherein said portable communication terminal is configured to:
transmit an invite message to said second conference endpoint, said invite message including an identifier identifying said portable communication terminal, and
receive an acknowledge message from said second conference endpoint.

22. System according to one of the clams 13-21,
wherein said portable communication terminal is configured to
relay conference media between said endpoints via said portable communication terminal.

23. System according to one of the claims 13-15 or 17-22, wherein the portable communication terminal includes a conference soft client, and said portable communication terminal is configured to
establish a conference communication between said first endpoint and said conference soft client in said portable communication terminal, and
move said conference communication from said mobile communication terminal to said second conference endpoint by establishing a conference communication between said first and second conference endpoints.
